(19) United States
(12) Patent Application Publication
(10) Pub. No.: US 2017/0076374 A1
(43) Pub. Date: Mar. 16, 2017

(54) TRADING INTEREST RATE SWAPS ON A YIELD BASIS ON A FUTURES EXCHANGE

(71) Applicant: Stonewyck Investments LLC, Chatham, NJ (US)

(72) Inventor: Michael J. Hyland, JR., Chatham, NJ (US)

(21) Appl. No.: 15/266,060

(22) Filed: Sep. 15, 2016

Related U.S. Application Data
(60) Provisional application No. 62/219,007, filed on Sep. 15, 2015.

(51) Int. Cl. G06Q 40/04

(52) U.S. Cl. CPC G06Q 40/04

(57) ABSTRACT

Methods, systems, and apparatus, including computer programs encoded on a non-transitory computer-readable medium, for receiving a request from a computing device for a spread quote of futures contracts, the spread quote specifying a ratio of single sided swap futures fixed rate contracts that would be exchanged for a single sided swap futures floating rate contract, transmitting to the computing device, responsive to receiving the request, a plurality of spread quote bids and/or offers, receiving, from the computing device, an order to exchange a number of single sided swap futures fixed rate contracts for a single sided swap futures floating rate contract at a particular ratio that matches one of the bids and offers, and responsive to receiving the order, executing a transaction to exchange a number of single sided swap futures fixed rate contracts for a single sided swap futures floating rate contract at the particular ratio.

### CROSS-REFERENCE TO RELATED APPLICATION

This application claims the benefit of U.S. provisional patent application No. 62/219,007, filed on Sep. 15, 2015, the entire contents of which are hereby incorporated by reference.

### TECHNICAL FIELD

The present disclosure relates to trading interest rate swaps on a yield basis on a futures exchange.

### SUMMARY

In general, an innovative aspect of the subject matter described in this specification can be embodied in methods that include the actions of receiving a request from a computing device for a spread quote for single sided swap futures contracts, the spread quote specifying a ratio of single sided swap futures fixed rate contracts that would be exchanged for a single sided swap futures floating rate contract. The methods include the actions of transmitting to the computing device, in response to receiving the request, a plurality of quotes including spread quote bids or spread quote offers. The methods include the actions of receiving, from the computing device, an order to exchange a number of single sided swap futures fixed rate contracts for a single sided swap futures floating rate contract at a particular ratio that matches one of the spread quote bids or offers. The methods further include the actions of executing a transaction to exchange a number of single sided swap futures fixed rate contracts for a single sided swap futures floating rate contract at the particular ratio in response to receiving the order.

Other embodiments of this aspect include corresponding computer systems, apparatus, and computer programs recorded on one or more computer storage devices, each configured to perform the actions of the methods. A system of one or more computers can be configured to perform particular actions by virtue of having software, firmware, hardware, or a combination of them installed on the system that in operation causes or cause the system to perform the actions. One or more computer programs can be configured to perform particular actions by virtue of including instructions that, when executed by data processing apparatus, cause the apparatus to perform the actions.

The foregoing and other embodiments can each optionally include one or more of the following features, alone or in combination. For example, in some implementations, the ratio is a non-integer number. A fixed coupon rate associated with the single sided swap futures fixed rate contract may be 1%. The spread quote may include a quantity of single sided swap futures floating rate contracts that would be exchanged for single sided swap futures fixed rate contracts at the specified ratio. The single sided swap futures fixed rate contract may include one or more terms selected from a group consisting of start date, end date, notional amount, and coupon frequency. The single sided swap futures fixed rate contract may be expressed as a fixed annuity with a payment amount equal to a fixed dollar number instead of a notional amount multiplied by a coupon rate. The single sided swap futures floating rate contract may include one or more terms selected from a group consisting of start date, end date, notional amount, coupon frequency, and floating index. One or more terms of the single sided swap futures fixed rate contract are identical with corresponding one or more terms of the single sided swap futures floating rate contract. Conducting spread trading of swap futures may include receiving a plurality of spread quote bids and offers from one or more other computing devices.

Implementations and embodiments may include one or more advantages. For example, in some implementations, the technologies described herein relate to replicating over-the-counter interest rate swaps on a future exchange in order to reduce data storage requirements, system processing steps, as well as system processing time, and thus improve the way in which a system stores and retrieves data in conducting interest rate swaps trading, warehousing, and administration. In particular, the subject matter described herein relates to systems and methods for spread trading of swap futures, in which a first futures contract replicates the fixed leg of an interest rate swap (with an interest rate coupon of exactly 1%) and a second futures contract replicates the floating legs of the same interest rate swap. The technologies described herein enable a market participant to exactly replicate cash flows of over-the-counter interest rate swaps by spread trading (e.g., simultaneously exchanging) a specific ratio of the first and second futures contracts on the future exchange, in which the ratio may be a non-integer multiple of the floating leg contract. The systems and computer-implemented methods allow the market participant to (i) adjust the trading ratio of the first and second futures contracts so that they can replicate over-the-counter interest rate swaps of any notional amount and any fixed interest rate and (ii) to quote trading orders on the future exchange using the same method as used in the over-the-counter market (e.g., yield not price). By providing the first and second futures contracts that can replicate over-the-counter interest rate swaps, the techniques described below may improve the way a system stores and processes data in order to provide a more efficient and less data intensive approach to implementing interest rate swaps. In particular, advantages of the techniques disclosed herein may include, for example, elimination or reduction in computational burdens associated with trading and maintaining existing over-the-counter interest rate swaps by eliminating or reducing the monitoring of changes to a floating rate of a trade during the life of a swap, eliminating or reducing the calculation of cash flows resulting from the changes in a floating rate relative to an agreed upon fixed rate, eliminating or reducing periodic transaction recordation over the life of the swap, eliminating or reducing the number of yield curve calculations, as well as the calibration of such calculations to market data (providing an associated reduction in data generation), and reduction in cash flow calculations. With the decrease in the amount of data storage and processing time required to implement the spread trading and administration of swap futures, compared to standard computer-implemented over-the-counter interest rate swaps, spread trading of swap futures provides functional improvements to the systems on which the swaps are traded, warehoused, and administrated. Other advantages may also be possible.

The details of one or more embodiments of the subject matter of this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is a schematic that illustrates an example environment for transacting over-the-counter interest rate swaps.

FIG. 2 is a schematic that illustrates an example of current interest rate swap futures contracts.

FIG. 3 is a schematic that illustrates an example of spread trading of swap futures contracts.

FIG. 4 is a schematic that illustrates an example environment for conducting spread trading of swap futures contracts.

FIG. 5 is an example trading screen available to market participants who are conducting spread trading of swap futures contracts.

FIG. 6 is a schematic that illustrates an example of netting swap futures contracts.

FIG. 7 is a schematic that illustrates an example process for conducting spread trading of swap futures contracts.

### DETAILED DESCRIPTION

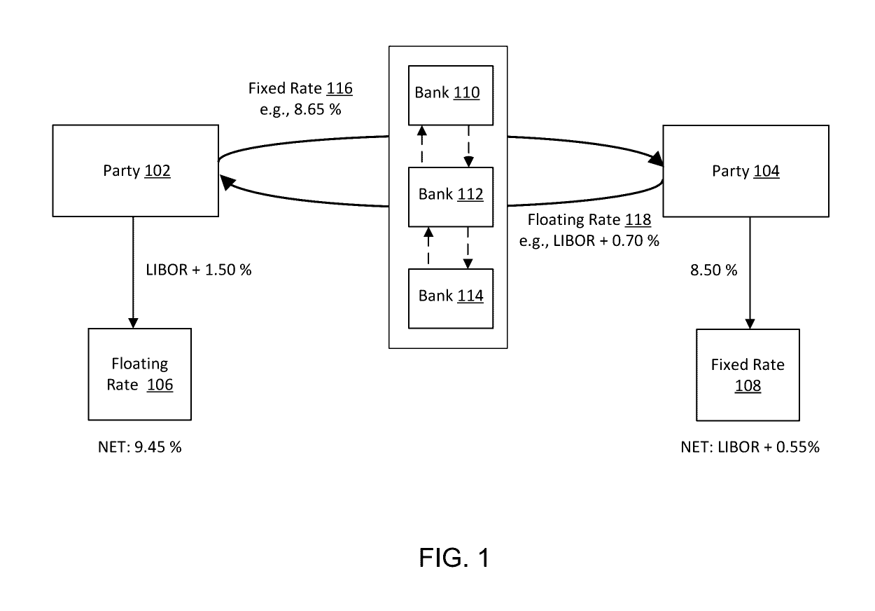

FIG. 1 illustrates an example environment for transacting existing over-the-counter interest rate swaps. A swap is a type of financial derivative instrument. An interest rate swap or IRS is a type of over-the-counter swap that is used for hedging or speculating against changes in interest rates. One type of interest rate swap is a “fixed/floating” IRS, in which the first counterparty agrees to make fixed payments of interest to the second counterparty over a period of time (for example, five years) on a notional amount of principal. The second counterparty agrees to make payments to the first counterparty that fluctuate over the same period of time in accordance with fluctuations in a “floating” interest rate (such as the London Interbank Offered Rate (LIBOR) 3 month rate). The period of time during which the swap is effective may be referred to as its “tenor”. The party that receives the fixed side of the interest rate swap may do so in order to hedge against future interest rate fluctuations. The party that receives the floating side of the IRS may do so in order to speculate on future changes in interest rates.

For example, as shown in FIG. 1, party 102 and party 104 can enter an interest rate swap contract to exchange their existing obligation for their desired obligation. In particular, party 102 is currently making payments to a third-party at a floating rate 106 (such as LIBOR+1.50%), and party 104 is currently making payments to another third-party at a fixed rate 108 (such as 8.50%). However, for some reasons, party 102 wants to pay a fixed rate instead of a floating rate, and party 104 wants to pay a floating rate instead of a fixed rate. Thus, party 102 and party 104 can enter an over-the-counter “fixed/float” IRS, in which party 102 agrees to make payments to party 104 at a fixed rate 116 (e.g., 8.65%). Party 104, in exchange, agrees to make payments to party 102 at a floating rate 118 (e.g., LIBOR+0.70%). Party 102 and 104 can negotiate the fixed rate 116 and floating rate 118 over-the-counter, and other terms for the “fixed/float” IRS such as notational amount, tenor, and frequency of payment can be fully customized by the two parties. By entering into the interest rate swap contract, parties 102 and 104 can exchange their existing obligation for their desired obligation. For example, in this case, the net result is that party 102 needs to make payments at a fixed rate of

8.65%−(LIBOR+0.70%)+(LIBOR+1.50%)=9.45%.

The party 104 needs to make payments at a floating rate of

(LIBOR+0.70%)−8.65%+8.50%=LIBOR+0.55%

In some implementations, it may require more than one trade to complete an IRS. For example, as shown in FIG. 1, to enter the desired IRS, party 102 can trade with bank 110. Bank 110 can hedge the trade with bank 112. Bank 112 can hedge with bank 114. Finally, bank 114 can trade with party 104.

In addition to “fixed/float” IRS, there are other types of swaps such as “float/float” IRS, which involves the exchange of two floating rates, or “cross-currency” IRS, which involves the exchange of interest flows in different currencies. IRSs and other swaps may also be employed as part of financial strategies that are much more complex than simple hedging or speculating strategies.

Although over-the-counter IRSs enable the involved parties to make payments at their desired fixed or floating rates, there are numerous technical drawbacks associated with the implementations of existing IRSs using computer systems. In particular, implementations of existing IRSs may require a substantial consumption of computer resources to monitor and to maintain an over-the-counter IRS trade over the life of the trade. For instance, because the floating rate portion of the IRS changes, the computer systems keep track of the changes and update the rate regularly. For example, a 10 year swap with quarterly floating rate resets requires 40 updates over the life of the swap trade. In addition, the computer systems may need to record accounting transactions on a regular basis, e.g., in the preceding example, 40 payments and 40 receipts of payments may need to be recorded.

Further, the computer systems may need to repeatedly and periodically recalculate the trade value of each IRS in an IRS portfolio, as the interest rate environment constantly changes. At the inception of the swap, the IRS trade value is near zero since the fixed leg rate is often chosen to make the value of the fixed leg payments roughly equal to the expected value of the floating leg payments (fair value). Because the interest rates move due to changes in the economic cycle, one leg of the IRS often becomes more valuable than the other, introducing credit risk such that the party with the “better” side of the IRS doesn't want their counterparty to go bankrupt. Thus, each trade in an IRS portfolio may need to be valued multiple times per day for daily profit and loss, for regulatory oversight, and for determining credit risk. The valuations are computationally intense and time-consuming and thus impose great computational burdens on the computer systems on which the over-the-counter interest rate swaps are stored and maintained. For example, the daily valuations may require the computer systems to use a significant amount of database storage, computer memory, and processing power to:
Analyze and calibrate market data to create yield curves,
Apply yield curves to estimate future floating rates,
Calculate future cash flows,
Present value of those cash flows to today's value,
Perform additional calculations to adjust for credit terms and risk mitigates associated with each trade or counterparty, and
Record details and adjusted terms of each IRS trade on a regular basis over the life of each IRS.

In some cases, the number of over-the-counter IRSs can rapidly increase over time, requiring the computer systems to manage increasingly larger number of IRSs (including the calculations, data generation and data storage associated with the foregoing daily valuations).

Furthermore, in some implementations, it may be difficult to exit an over-the-counter IRS trade prior to the expiration of its tenor. Unlike other financial instruments (such as stocks and bonds) that are standardized and can be easily sold on liquid markets, as discussed above, IRSs are fully customized. Therefore, exiting an IRS trade is time consuming as it involves a process of confirming each of the IRS details with a variety of competing counterparties in order to negotiate an exit price near fair value. To avoid this time-consuming process, most IRS participants choose to “offset” an undesired IRS by transacting a second IRS with features that cancel out those of the first IRS. For example, if a hedge fund enters into a first swap with Bank A, the hedge fund may try to offset that first swap by entering into a second swap with Bank B, resulting in two outstanding swaps. Extrapolating the behavior for each party to a swap and for each swap, the number of outstanding swaps can expand rapidly, leading to an extremely large number of trades for the computer systems to monitor and manage. As the number of IRS trades grows, there is an increasing demand for computer resources, which challenges the existing computer systems.

Meanwhile, another type of financial derivative is a financial futures contract such as a stock market index futures contract. A futures contract is a contract between two parties to buy or sell an asset for a price agreed upon today (the futures price) with delivery and payment occurring at a future point. Because it is a function of an underlying asset, a futures contract is considered a derivative product. Futures contracts are negotiated at future exchanges, which act as a marketplace for buyer and seller. Futures can be used for both hedging and speculating. Typically stock market futures contracts require cash settlement on the expiration date in an amount based on the reference stock market index. “Dow futures” are one example of a stock market futures contract, and use the Dow Jones Industrials index as the reference index.

From market participants' perspectives, futures contracts have several benefits. For example, because futures are settled through clearinghouses, the clearinghouse and margin requirements limit each party's credit risk. Additionally, centralized trading allows for greater transparency of the market price. Futures contracts also benefit from regulatory advantages with respect to capital or accounting pronouncements.

Interest rate swaps may be traded on future exchanges. These may be referred to as interest rate swap futures. Interest rate swap futures may offer advantages over interest rate swaps implemented over-the-counter. For example, in some implementations, as a result of standardization requirements, interest rate swap futures can be easily traded on futures exchanges, allowing parties to quickly exit undesired positions.

Current implementations of IRS futures are typically underutilized though, because they are defined to include a standardized fixed rate that tries to approximate the over-the counter swap rate. As such, counterparties trading swap futures may need to exchange cash upfront to create a fair value transaction. This upfront payment is contrary to the over-the-counter interest rate swap market where counterparties may prefer to adjust the fixed rate of the IRS instead of exchanging cash upfront. Furthermore, because the translation between price and yield is typically not linear, it is difficult, in some implementations, to compare interest rate swaps conducted through over-the-counter markets and on futures markets. Again, as a result, IRS futures are typically underutilized as can be illustrated by the paltry trading volumes of such currently available products.

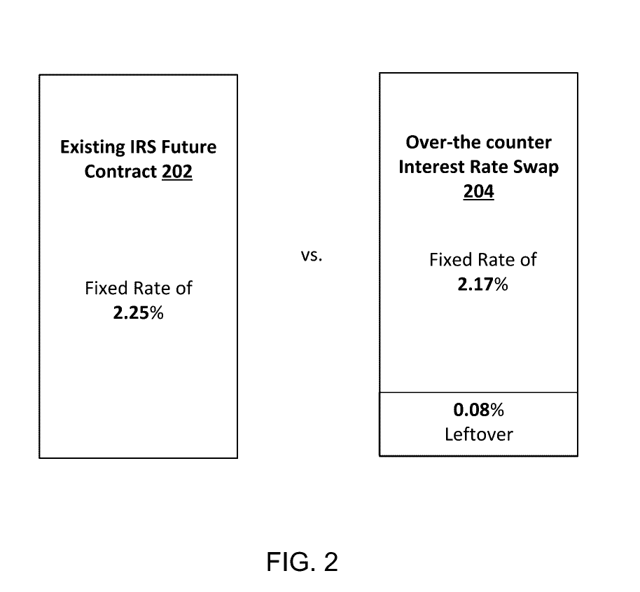

FIG. 2 is a schematic that illustrates an example of current interest rate swap futures contracts. In this example, an interest rate swap futures contract 202 has a fixed rate of 2.25%. The contract definition of the futures contract 202 is:

The buyer of the contract agrees to receive 2.25% fixed vs.

The seller of the contract agrees to receive a floating rate.

Because the futures contract definition has locked the fixed rate at 2.25% (in order to create a standardized contract), the counterparties need to agree to transact the futures contract with upfront cash equivalent amounts to reflect the difference between the present value of the market swap rate and the standardized fixed rate of the futures contract. In particular, as shown in FIG. 2, a fixed rate of an IRS 204 in the over-the-counter IRS market is 2.17%. In this case, the fixed rate of the futures contract is greater than the market swap rate (2.25%>2.17%). In order to trade the futures contract, the buyer (receiver of fixed) of the 2.25% futures fixed rate will need to compensate the seller (payer of fixed) with an upfront cash payment. The agreed upon payment will be the perceived value of the extra 0.08% that is being exchanged between the buyer and seller.

However, there are technical difficulties associated with computing the upfront cash payment (e.g., the futures price) equivalent to the difference between the over-the-counter rate and the futures rate. Specifically, implementations of the computation process may be computationally intense and time-consuming. In order to properly calculate the futures price, each counterparty must use their computer systems to determine the IRS yield curve for each tenor out to the final tenor of the IRS underlying the futures contract. For example, for a futures contract on a ten year IRS, the computer system on which the swap is implemented may need to determine for each counterparty the swap rates at year 1, 2, 3, etc. out to year 10. The computer systems then may need to convert each of the swap yields into dollar value components and sum them up for an approximate futures price. Adjustments to that price then may need to be made based on credit or collateral terms at the specific futures exchange before a futures price can finally be quoted. Because of the computational burdens and time consumption, IRS futures may suffer from low acceptance by market participants.

The present disclosure relates to improving the way a system stores and processes data in order to provide a more efficient and less data intensive approach to implementing interest rate swap futures. The technologies are related to providing futures contracts that, when used together, can replicate over-the-counter interest rate swaps and can be traded on a future exchange. In particular, this specification describes systems and methods to provide spread trading of swap futures, in which a first futures contract replicates the fixed leg of an interest rate swap (with an interest rate coupon of exactly 1%) and a second futures contract replicates the floating legs of the same interest rate swap. The technologies enable a market participant to exactly replicate cash flows of over-the-counter interest rate swaps by trading (e.g., simultaneously) a specific ratio of the first and second futures contracts on the future exchange, in which the ratio may be a non-integer multiple of the floating leg portion of the contract. The systems allow the market participant to (i) adjust the trading ratio of the first and second futures contracts so that they can replicate over-the-counter interest rate swaps of any notional amount and any fixed interest rate and (ii) to quote trading orders on the futures exchange using the same method as used in the over-the-counter market (e.g., yield not price). By providing the first and second futures contracts that can replicate over-the-counter interest rate swaps, the techniques described below may improve the way a system stores and processes data in order to provide a more efficient and less data intensive approach to implementing interest rate swaps. In particular, advantages of the techniques disclosed herein may include, for example, elimination or reduction in computational burdens associated with trading and maintaining existing over-the-counter interest rate swaps while preserving the technological benefits of trading futures contracts on a future exchange.

The systems and methods described herein enable interest rate swap market participants to transact interest rate swap futures on a yield basis with two new types of futures contracts. For the purposes of the following example, the two new futures contracts are referred to as a “Single Sided Swap Future Fixed Leg” (3SFX) and a “Single Sided Swap Future Floating Leg” (3SFL). Spread trading of the two types of futures contracts will allow for the quoting of a synthetic IRS Futures contract similar to that of the over-the-counter IRS market. Spread trading of futures involves simultaneously buying a particular contract and selling a related contract against it. That is, by creating a futures based product that is both economically equivalent to the over-the-counter product and that is quoted in a manner that is consistent with the over-the-counter swap market (e.g., the coupon moves, not the price), the systems and methods described herein provide a financial derivative that has the advantages of a futures contract (e.g., standardized contract that can be traded easily on a future exchange, clearinghouse and margin requirements to limit credit risk, netting ability, and greater transparency of market price) without the need to provide cash upfront or to translate a cash upfront requirement to a rate for comparison with over-the-counter products.

An example of a 3SFX contract is set forth as follows:

| | Example |
|---|---|
| Start Date | Mar. 15, 2016 ** |
| End Date | Mar. 15, 2026 ** |
| Notional Amount | $100,000 ** |
| Coupon Frequency | Semi-annual |
| Day Count Fraction | 30/360 |
| Holiday Calendar | New York |
| Seller of contract makes payments | |
| Buyer of contract receives payments | |

An example of a 3SFL contact is set forth as follows:

| | Example |
|---|---|
| Start Date | Mar. 15, 2016 ** |
| End Date | Mar. 15, 2026 ** |
| Notional Amount | $100,000 ** |
| Coupon Frequency | Quarterly |
| Day Count Fraction | ACT/360 |
| Holiday Calendar | New York and London |
| Floating Index | 3M LIBOR |
| Seller of contract makes payments | |
| Buyer of contract receives payments | |

Items marked with the double stars “**”should be identical between the two contracts for this methodology to work.

The key to allowing for a yield basis quotation for the swap transaction in the futures market (as is the convention in the much more liquid over-the-counter swap marketplace) would be the choice for the amount of the fixed coupon associated with the 3SFX contract. Rather than trying to choose a fixed rate that is near the market swap rate at the time the contract is listed, the fixed coupon rate associated with the 3SFX would be exactly 1%. An equivalent way of noting this would be to say that the 3SFX contract paid $1,000 of fixed interest per year ($100,000*1%=$1,000).

Given these contract specifications, market participants could exactly replicate the economic cash flows of over-the-counter interest rate swaps by simultaneously trading a certain ratio of 3SFX vs. 3SFL. The ratio of 3SFX vs. 3SFL contracts that should be traded against each other is equal to the swap rate that the counterparties are trying to replicate.

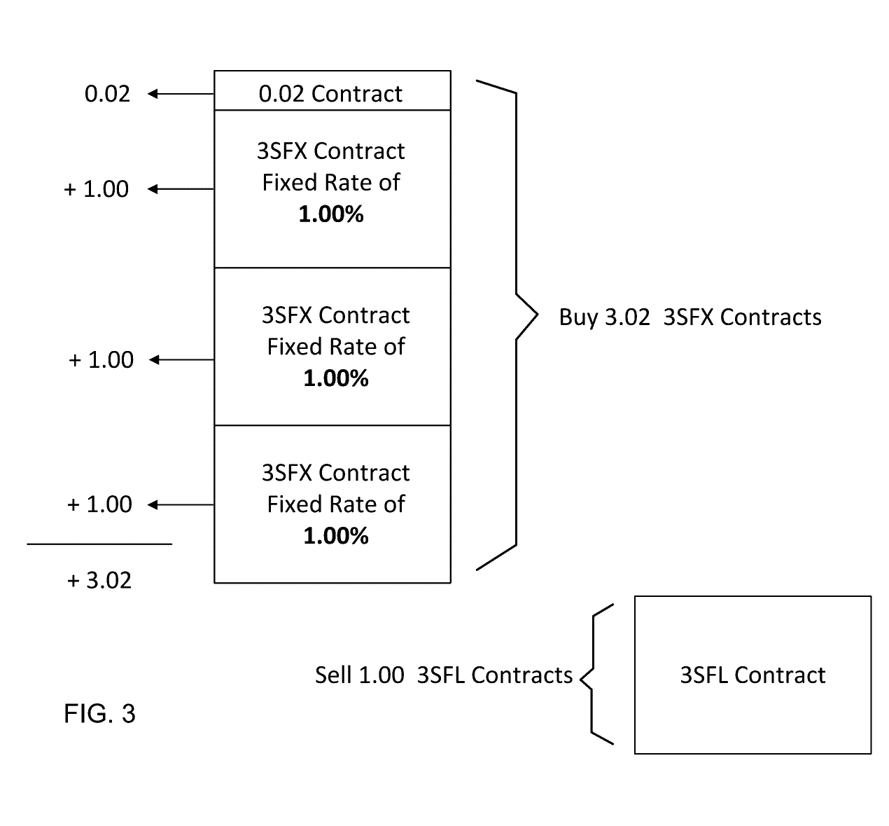

For example, FIG. 3 is a schematic that illustrates an example of spread trading of swap futures contracts. In this example, two market participants want to replicate a 3.02% interest rate swap. They simultaneously trade:

One 3SFL contract vs. 3.02 3SFX contracts

This would result in the market participant having a $100,000 notional amount on the float leg of the swap and:

3.02 contracts*(1% interest*$100,000 notional per contract)

of annual fixed interest. Rearranging the terms of this equation shows the market participant would have 3.02% interest on $100,000 notional on the fixed leg of the swap.

Note that in this example the futures exchange would have to allow for fractional contract trading of the 3SFX contract. If the exchange did not want to allow for fractional contract trading, the coupon rate associated with the 3SFX contract could be decreased to the desired smallest tradable increment and then the number of contracts needed would increase proportionally. Either way, the computational burdens associated with this type of transacting would require implementation via computer software and hardware.

It is expected that creating a futures based product that is both economically equivalent to the over-the-counter product and that is quoted in a manner that that is consistent with the over-the-counter swap market (e.g., the coupon moves, not the price) will make the futures market a more popular destination for market participants.

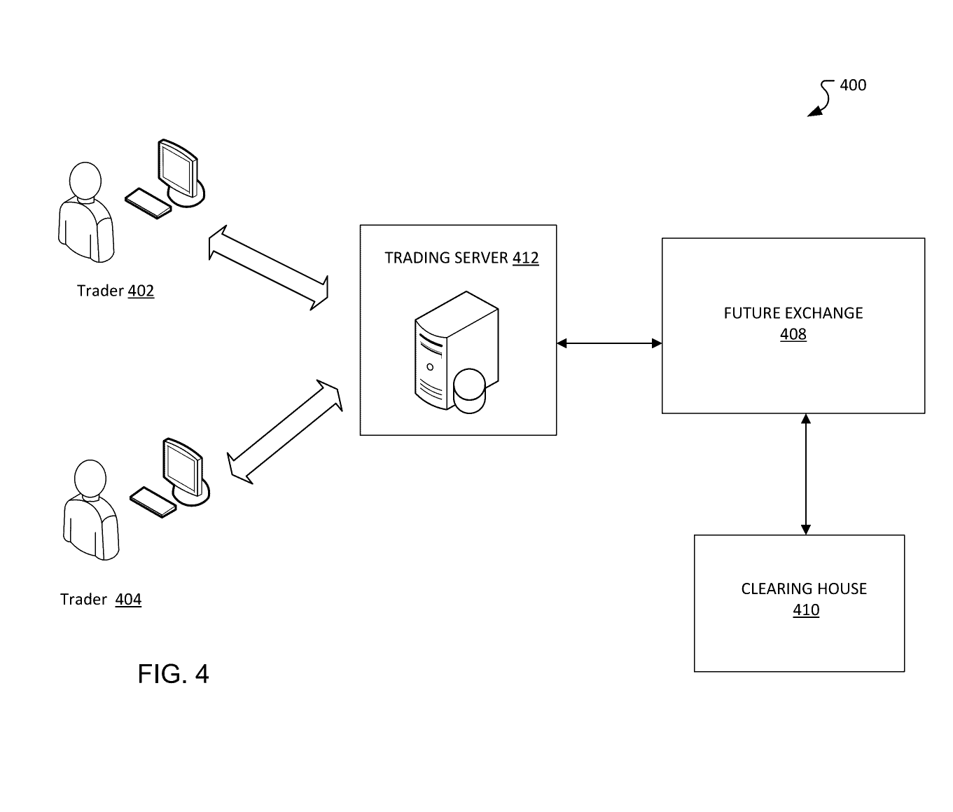

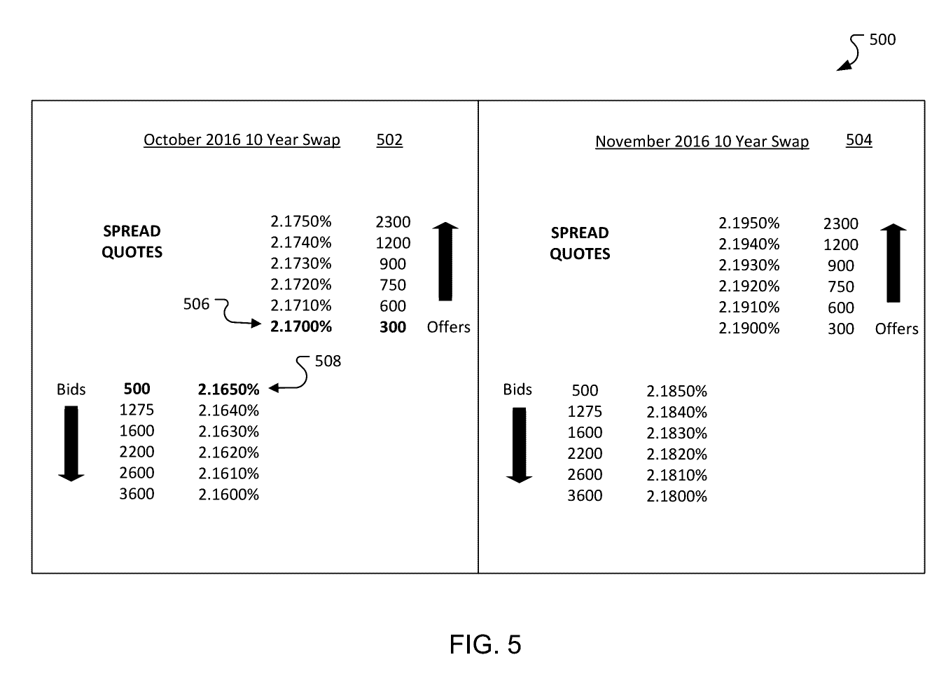

FIG. 4 is a schematic that illustrates an example environment 400 for conducting spread trading of swap futures contracts. The example environment 400 is a simplified block diagram of computer architecture and associated networks that enables market participants, such as traders 402 and 404, to conduct spread trading of futures contracts, and that allows quoting of a synthetic IRS futures contract that are similar to that traded in an over-the-counter IRS market. With such architecture, trades occur on an electronic future exchange 408 and are cleared by an exchange clearinghouse 410. In particular, traders 402 and 404 place orders for futures contracts electronically by way of trading server 412 accessible by traders (e.g., in a trading firm) to place buy and sell orders for futures contracts or other asset classes directly with an electronic future exchange. The trading server 412 can be connected to the future exchange 408 by a communication network such as the Internet or other computer network. The traders 402 and 404 are able to place orders with the future exchange 408 by accessing a trading program that runs on the trading server 412 using a computing device. Subsequently, the trading server 412 sends the order requests to the future exchange 408. The future exchange 408 acknowledges the receipt of the order and the order acknowledgement is transmitted back to the traders 402 and 404. After the buy/sell orders have been matched, clearing of the trades is accomplished by the clearinghouse 410, associated with the future exchange 408 and the traders 402 and 404 are notified in the manner discussed above. In the example system, all trades are accomplished at the future exchange 408. The process of matching buy/sell order is described in the following description associated with FIG. 5.

FIG. 5 is an example trading screen available to market participants who are conducting spread trading of swap futures contracts. The sample trading screen shows how a trade would occur with the swap futures contracts. There are two swap futures contracts displayed in the screen: a first 10 year swap futures contract that will expire in October 2016 and a second 10 year swap futures contract that will expire in November 2016 (given that the present is September 2016). As shown in FIG. 5, the trading screen includes multiple bids and offers submitted by market participants in a manner that is equivalent to an over-the-counter IRS market quote. For example, to replicate an over-the-counter IRS market quote to receive a fixed rate of 2.1700% and pay floating rate for a notational amount of $30 million, as show in FIG. 5, a trader 506 can submit a spread quote offer that indicates that the trader 506 is willing to buy 2.1700 3SFX contracts in order to sell 1.00 3SFL contract, and the quantity of 3SFL contracts that he is willing to sell is 300, which corresponds to the notional amount of $30 million. Another trader, such as trader 508, wants to replicate an over-the-counter IRS market quote to receive floating rate and pay a fixed rate of 2.1650% for a notional amount of $50 million. In this case, the trader 508 can submit a spread quote bid to indicate that the trader 508 is willing to sell 2.1650 3SFX contracts in order to buy 1.00 3SFL contract, and the quantity of 3SFL contracts that he is willing to buy is 500, which corresponds to the notional amount of $50 million. The future exchange will match spread quote bids and offers submitted by market participants such as trader 506 and 508. When there is a match, the matching orders will be executed.

Implementations of the subject matter provide technical improvements to the computer systems used for implementing swaps by combining the technical advantages of trading futures contracts on a future exchange while avoiding the technical drawbacks associated with over-the-counter IRSs.

For example, implementations of the subject matter requires less computer resources for monitoring, updating, and managing swap trades. As discussed above, over-the-counter IRSs are fully customized and difficult to exit. Thus, the number of IRSs that are traded by market participants are growing rapidly, as market participants prefer to enter a new IRS contract to offset a position instead of exiting an existing contract. In addition, because over-the-counter IRSs are fully customized, they cannot be netted together. The inability to net over-the-counter IRSs makes trading databases unnecessarily large, which poses a technical challenge to the computer systems.

In contrast, the 3SFX and 3SFL contracts have predefined terms (e.g., the fixed coupon rate associated with the 3SFX is exactly 1%) and thus can be easily traded on a futures exchange. Therefore, a party can quickly exit an undesirable swap futures contract instead of entering into another contract. As such, the number of outstanding futures contracts does not necessarily grow over time. In addition, as the 3SFX and 3SFL contracts are fungible, they provide a great opportunity for netting. Current methodologies for netting down different positions of over-the-counter IRS contracts among active market participants are cumbersome and rely on multi-lateral cooperation. Implementations of the subject matter enable the computer systems to net 3SFX contracts against 3SFX contracts and to net 3SFL contracts against 3SFL contracts.

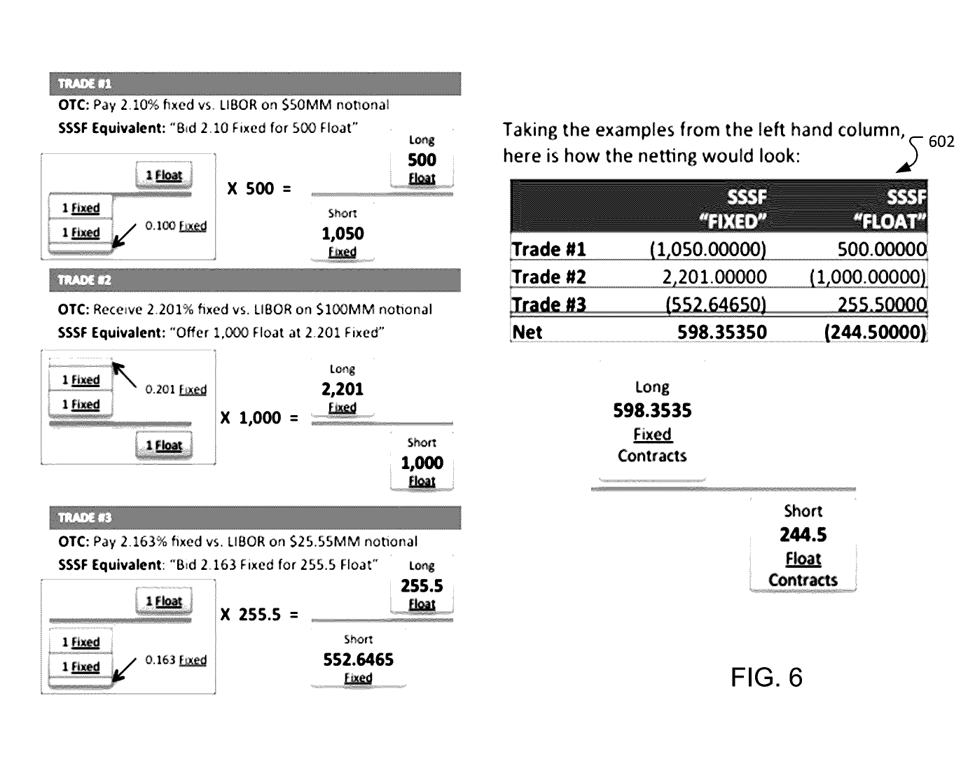

For example, FIG. 6 is a schematic that illustrates an example of netting swap futures contracts. In this example, a trader executes swap futures trades including trade 1, trade 2, and trade 3. Trades 1, 2, and 3 can be executed at the same time or at different time. To execute trade 1, the trader sells 2.10 3SFX contracts in order to buy 1.00 3SFL contract, and the quantity of 3SFL contracts that he is willing to buy is 500, which corresponds to the notional amount of $50 million. To execute trade 2, the trader sells 1.00 3SFL contract in order to buy 2.201 3SFX contracts, and the quantity of 3SFL contracts that he is willing to sell is 1,000, which corresponds to the notional amount of $100 million. To execute trade 3, the trader sells 2.163 3SFX contracts in order to buy 1.00 3SFL contract, and the quantity of 3SFL contracts that he is willing to buy is 255.5, which corresponds to the notional amount of $25.55 million. As shown in Table 602, the computer systems can net the swap futures contracts positions of the three trades executed by the trader. The resulting net futures positions are the same as buying 598.3535 3SFX contracts and selling 244.5 3SFX contracts. Thus, the three trades done by the traders can be netted down to just one swap equivalent position.

Further, the process of transacting 3SFX and 3SFL contracts is less cumbersome than transacting current swap futures. As previously discussed, over-the-counter swap rates need to be converted into prices and dollar values in order to create equivalent prices for current swap futures. But, because 3SFX and 3SFL contracts are directly analogous to the over-the-counter market, market participants can use the exact same quotes for these futures contracts that they would use for over-the counter-swaps. Thus, the computer systems do not need to do nearly as many calculations to compare the over-the-counter market to the 3SFX and 3SFL futures market.

Therefore, by netting down swap futures positions, eliminating or reducing the need to frequently administer changing aspects of the trade (such as the floating rate), and eliminating several steps in the trade value computation process, implementations of the subject matter improve the computer systems by significantly reducing the computer resources consumed by the computer systems to monitor and manage swap trades (e.g., by reducing the size of trading databases, reducing the memory and processing power needed to store and update trading details, reducing the network traffic between the market participants and the computer systems each time a market participant requests information about trading positions, reducing the need for complex user interfaces to be generated and presented to market participants, etc.).

Additionally, implementations of the subject matter allow the computer systems to convert previously executed over-the-counter trades into futures contracts. In particular, most futures exchanges have a mechanism whereby “physical” commodities can be exchanged for “futures”. This process is referred to as an “exchange for physical” or “EFP”. One of the benefits of the 3SFX and 3SFL futures contracts is that they not only benefit new trading but can also help consolidate older, previously executed trades. For example, consider a swap trade done five years ago with a start date of Mar. 15, 2011 and an end date of Mar. 15, 2026. On Mar. 15, 2016 that swap trade will have details that will look exactly like the 3SFX and 3SFL contracts defined in the earlier example. Both counterparties to that over-the-counter swap could arrange to have the swap delivered to a futures exchange and converted into 3SFX and 3SFL contracts in order to enjoy the benefits of futures as compared to over-the-counter as described above.

Further, implementations of the subject matter provide market participants with the transparency and centralization of futures market that are lacking in the over-the-counter IRS market. Specifically, exchange-based trading involves the centralized communication of bid and offer prices to all direct market participants. By offering real-time price transparency through a centralized pool of liquidity, exchange-based trading ensures the most efficient price will prevail as traders are able to make decisions utilizing all available and relevant information. This is supported by user anonymity, which eliminates the distortion of market prices that is inherent within direct bilateral trading, and the associated rules-based trading environment of an exchange. Furthermore, exchange-based trading significantly reduces the time delay that occurs when over-the-counter trades are executed by providing same-day electronic clearing and settlement of products and funds. By offering a price that is determined by natural market mechanisms, exchange-based trading offers the most efficient trade conditions and is therefore positioned to benefit participating traders and also strengthen the market as a whole.

In addition, implementations of the subject matter benefits market participants by reducing the amount of paperwork per transaction. Specific to over-the-counter swap transactions, each trade is documented in the form of a multi-page trade confirmation. These confirmations must be prepared by the first counterparty, checked and signed by the second counterparty, then counter-signed by the first counterparty, and then recorded and stored for the life of the trade by both parties. In addition, the counterparties must complete an ISDA Master Agreement before the first trade is done. This document is much more rigorous to prepare (as compared to the trade confirmations) and also must be negotiated, signed, and stored by both counterparties. Conversely, because futures contracts have defined terms and can be traded within a futures exchange, the trade confirmation process is much less intense.

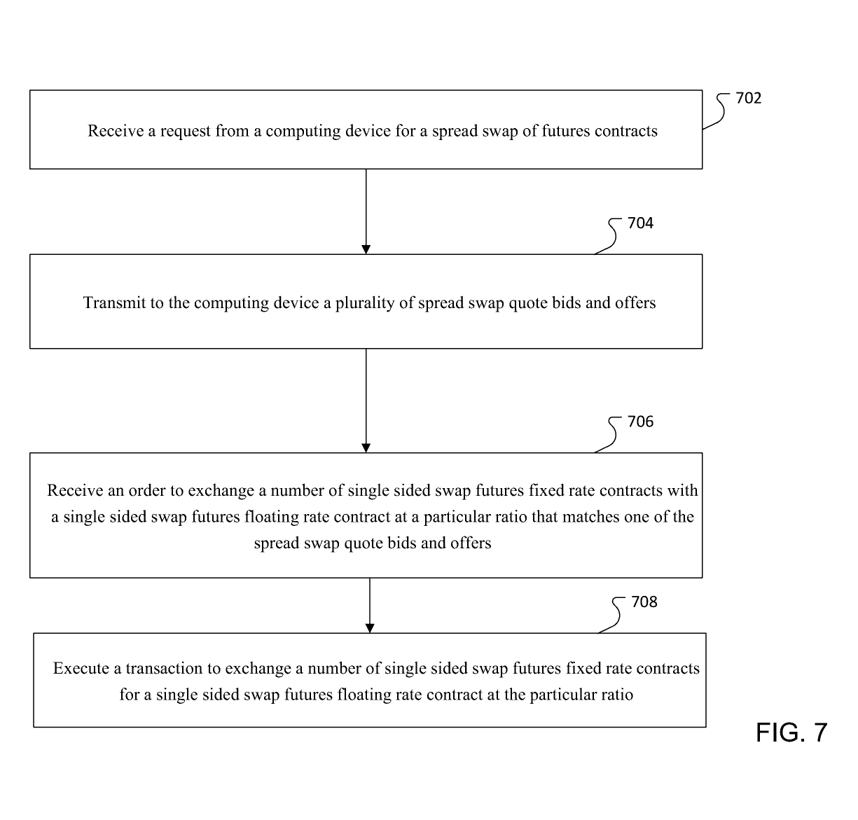

FIG. 7 is a schematic that illustrates an example process for conducting spread trading of swap futures contracts using, for example, the environment 400 shown in FIG. 4. In a first step, a trader (e.g., trader 402) sends a request (702) using a computing device to the trading server 412. Included in the request could be a spread quote bid or offer. The spread quote is a quote for trading two types of futures contracts (single sided swap futures fixed rate contract, 3SFX, and single sided swap futures floating rate contract, 3SFL), in which the ratio of 3SFX to 3SFL is equal to the swap rate in over-the-counter market that the trader 402 is trying to replicate. In other words, the spread quote specifies a ratio of 3SFX contracts that would be exchanged for a 3SFL contract. The spread quote further includes a quantity of 3SFL contracts that would be exchanged for a number 3SFX contracts at the specified ratio in order to replicate a specific notional amount. For example, if the trader 402 wants to replicate an over-the-counter IRS with a notional amount of $50 million, the quantity of 3SFL contracts that need to be exchanged is 500. In response to receiving the request, the trading server 412 transmits (704) a plurality of spread quote bids and offers to the computing device of the trader 402. The plurality of spread quote bids and offers could have been previously submitted by other traders using other computing devices. After receiving the plurality of spread quote bids and offers, the trader 402 submits an order to the trading server 412 to exchange a number of 3SFX contracts with a 3SFL contract at a particular ratio that matches one of the plurality of spread quote bids and offers. The trading server 412 receives (706) the order, and in response to receiving the order, executes (708) a transaction to exchange a number of 3SFX contracts for a 3SFL contract at the particular ratio.

Implementations of the subject matter and the operations described in this specification can be realized in digital electronic circuitry, or in computer software, firmware, or hardware, including the structures disclosed in this specification and their structural equivalents, or in combinations of one or more of them. Implementations of the subject matter described in this specification can be realized using one or more computer programs, e.g., one or more modules of computer program instructions, encoded on computer storage medium for execution by, or to control the operation of, data processing apparatus. Alternatively or in addition, the program instructions can be encoded on an artificially generated propagated signal, e.g., a machine-generated electrical, optical, or electromagnetic signal that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially generated propagated signal. The computer storage medium can also be, or be included in, one or more separate physical components or media (e.g., multiple CDs, disks, or other storage devices).

The operations described in this specification can be implemented as operations performed by a data processing apparatus on data stored on one or more computer-readable storage devices or received from other sources.

The term “data processing apparatus” encompasses all kinds of apparatus, devices, and machines for processing data, including by way of example a programmable processor, a computer, a system on a chip, or multiple ones, or combinations, of the foregoing. The apparatus can include special purpose logic circuitry, e.g., an FPGA (field programmable gate array) or an ASIC (application specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a stand alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both. Elements of a computer can include a processor for performing actions in accordance with instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few. Devices suitable for storing computer program instructions and data include all forms of non volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, implementations of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Implementations of the subject matter described in this specification can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some implementations, a server transmits data (e.g., an HTML page) to a client device (e.g., for purposes of displaying data to and receiving user input from a user interacting with the client device). Data generated at the client device (e.g., a result of the user interaction) can be received from the client device at the server.

While this specification contains many specific implementation details, these should not be construed as limitations on the scope of any implementation of the present disclosure or of what may be claimed, but rather as descriptions of features specific to example implementations. Certain features that are described in this specification in the context of separate implementations can also be implemented in combination in a single implementation. Conversely, various features that are described in the context of a single implementation can also be implemented in multiple implementations separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products.

In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

Thus, particular implementations of the subject matter have been described. Other implementations are within the scope of the following claims.

What is claimed is:

1. A computer-implemented method of conducting spread trading of swap futures, the method comprising:
receiving, at an electronic processor, a request from a computing device for a spread quote of futures contracts, the spread quote specifying a ratio of single sided swap futures fixed rate contracts that would be exchanged for a single sided swap futures floating rate contract;
transmitting to the computing device, in response to receiving the request, a plurality of spread quote bids and/or offers;
receiving, from the computing device, an order to exchange a number of single sided swap futures fixed rate contracts for a single sided swap futures floating rate contract at a particular ratio that matches one of the plurality of spread quote bids and/or offers; and
in response to receiving the order, executing a transaction to exchange a number of single sided swap futures fixed rate contracts for a single sided swap futures floating rate contract at the particular ratio.

2. The method of claim 1, wherein the ratio is a non-integer number.

3. The method of claim 1, wherein a fixed couple rate associated with the single sided swap futures fixed rate contract is 1%.

4. The method of claim 1, wherein the spread swap quote further specifies a quantity of single sided swap futures floating rate contracts that would be exchanged for a number single sided swap futures fixed rate contracts at the specified ratio.

5. The method of claim 1, wherein the single sided swap futures fixed rate contract includes one or more terms selected from a group consisting of start date, end date, notional amount, and coupon frequency.

6. The method of claim 1, wherein the single sided swap futures floating rate contract includes one or more terms selected from a group consisting of start date, end date, notional amount, coupon frequency, and floating index.

7. The method of claim 1, wherein one or more terms of the single sided swap futures fixed rate contract are identical with corresponding one or more terms of the single sided swap futures floating rate contract.

8. The method of claim 1, further comprises receiving a plurality of spread quote bids and offers from one or more other computing devices.

9. A system for conducting spread trading of swap futures, the system comprising:
at least one computer; and
a computer-readable medium coupled to at least one computer having instructions stored thereon which, when executed by the at least one computer, cause the at least one computer to perform operations comprising;
receiving a request from a computing device for a spread quote of futures contracts, the spread quote specifying a ratio of single sided swap futures fixed rate contracts that would be exchanged for a single sided swap futures floating rate contract;
transmitting to the computing device, in response to receiving the request, a plurality of spread swap quote bids and/or offers;
receiving, from the computing device, an order to exchange a number of single sided swap futures fixed rate contracts for a single sided swap futures floating rate contract at a particular ratio that matches one of the spread swap quote bids and/or offers; and
in response to receiving the order, executing a transaction to exchange a number of single sided swap futures fixed rate contracts for a single sided swap futures floating rate contract at the particular ratio.

10. The system of claim 9, wherein the ratio is a non-integer number.

11. The system of claim 9, wherein a fixed couple rate associated with the single sided swap futures fixed rate contract is 1%.

12. The system of claim 9, wherein the spread quote further specifies a quantity of single sided swap futures floating rate contracts that would be exchanged for a number single sided swap futures fixed rate contracts at the specified ratio.

13. The system of claim 9, wherein one or more terms of the single sided swap futures fixed rate contract are identical with corresponding one or more terms of the single sided swap futures floating rate contract.

14. The system of claim 9, wherein the operations further comprise receiving a plurality of spread quote bids and/or offers from one or more other computing devices.

15. A non-transitory computer-readable medium coupled to at least one computer having instructions stored thereon which, when executed by the at least one computer, cause the at least one computer to conduct spread trading of swap futures, the operations comprising;
receiving a request from a computing device for a spread quote of futures contracts, the spread quote specifying a ratio of single sided swap futures fixed rate contracts that would be exchanged for a single sided swap futures floating rate contract;
transmitting to the computing device, in response to receiving the request, a plurality of spread swap quote bids and/or offers;
receiving, from the computing device, an order to exchange a number of single sided swap futures fixed rate contracts for a single sided swap futures floating rate contract at a particular ratio that matches one of the spread swap quote bids and/or offers; and
in response to receiving the order, executing a transaction to exchange a number of single sided swap futures fixed rate contracts for a single sided swap futures floating rate contract at the particular ratio.

16. The non-transitory computer-readable medium of claim 15, wherein the ratio is a non-integer number.

17. The non-transitory computer-readable medium of claim 15, wherein a fixed couple rate associated with the single sided swap futures fixed rate contract is 1%.

18. The non-transitory computer-readable medium of claim 15, wherein the spread quote further specifies a quantity of single sided swap futures floating rate contracts that would be exchanged for a number single sided swap futures fixed rate contracts at the specified ratio.

19. The non-transitory computer-readable medium of claim 15, wherein one or more terms of the single sided swap futures fixed rate contract are identical with corresponding one or more terms of the single sided swap futures floating rate contract.

20. The non-transitory computer-readable medium of claim 15, wherein the operations further comprise receiving a plurality of spread quote bids and/or offers from one or more other computing devices.
